(19) United States
(12) Patent Application Publication
(10) Pub. No.: US 2004/0220883 A1
(43) Pub. Date: Nov. 4, 2004

(54) Ammunition Cartridge Identification System and Method

(76) Inventor: Joshua Adam West, Austin, TX (US)

Correspondence Address: TAYLOR RUSSELL & RUSSELL, P.C., 4807 SPICEWOOD SPRINGS ROAD, BUILDING TWO SUITE 250, AUSTIN, TX, 78759, US

(21) Appl. No.: 10/249,705

(22) Filed: May 1, 2003

(51) Int. Cl. G06F 17/60

(52) U.S. Cl. 705/75

(57) ABSTRACT

A system and method for identifying a purchaser of ammunition from empty cartridge casings, sometimes found at a crime scene, by tagging the ammunition with purchaser identifying indicia at a point-of-sale. When an ammunition purchaser requests a purchase of ammunition and provides identification and identifying indicia at a point of sale location, a point-of-sale ammunition supplier verifies the validity of the provided purchaser information. If the purchaser information cannot be verified, the ammunition purchase may be refused. If the purchaser information can be verified, the point-of-sale supplier inscribes the purchaser identifying indicia on the ammunition cartridge casing and sells the purchaser the ammunition. The purchaser of the ammunition may be subsequently identified by the identifying indicia on the cartridge casing.

### BACKGROUND OF INVENTION

The invention relates generally to small arms ammunition and more particularly to a system and method for identification on each ammunition cartridge casing of the point-of-sale purchaser of the ammunition. This invention is particularly useful when the ammunition is suspected to have been used in the commission of a crime. When a firearm is used in the commission of a crime, the empty expended ammunition cartridge casings are usually left at the crime scene. It may be very useful to authorities that are charged with investigating a crime to be able to associate the empty casings with the original point-of-sale purchaser of the ammunition, who may or may not be the perpetrator of the crime. The present invention has the capability of providing this connection between the original purchaser of the ammunition and the empty casings found at a crime scene.

The tools that have been most useful by investigators of crimes involving firearms include linking bullet markings to a particular firearm or to other bullet markings by the unique signature made on the bullets by the lands and grooves within the barrel of the firearm through a bullet has passed, better known as “rifling marks”. This is a very useful tool in cases where a recovered fired bullet from a crime scene has not been disfigured to such an extent that it is not possible to identify barrel markings on the expended bullets. When barrel markings are identifiable on an expended bullet, they may be readily compared with other bullet markings, including markings on bullets fired from a suspected candidate firearm. However, in many cases, a recovered fired bullet from a crime scene is disfigured to such an extent that any barrel markings on the bullet are no longer discernable. If this inability to discern barrel markings on a fired bullet exists, crime investigators often rely on a chemical analysis of impurities in the fired bullet for comparison with other bullets that may have the same telltale pattern of impurities, and thus providing a link to a source of the ammunition. This latter method has recently come under suspect scrutiny, since some recent studies have indicated that bullet material from a same manufactured batch often have significantly different impurity properties, while bullet material from widely diverse manufactured material batches are almost identical. This has led to searches for other methods for linking fired bullets back to an acquisition source or a point-of-purchase. There is often a link between a fired bullet from a crime scene and the spent cartridge casings found at the crime scene. While a system has been disclosed that provides unique identifying markings on ammunition cartridge casings at time and place of manufacture, the difficulty of identifying and tracking these uniquely identified cartridge cases through normal channels of distribution from manufacturer to one or more distributors, to multiple retail point-of-purchase locations is cumbersome and difficult to implement.

### SUMMARY OF INVENTION

The present invention provides a system and method for uniquely identifying and designating the purchaser of ammunition on purchased ammunition cartridge casings at a point of purchase. The means for identifying the purchaser may be a social security number, a driver's license number, or other unique designation of the purchaser and at least one purchaser identification means such as a picture identification, fingerprint identification, or retinal-scan identification. The identifying or “tagging” means may be inscribed or embedded on cartridge casings by conventional methods such as a scribing tool or laser. In addition to the designation of the ammunition purchaser being inscribed on the cartridge casings, other tagging information may also be encoded into the inscription, such as date of purchase, ammunition batch number, seller or provider of the ammunition, location of the seller or provider, etc. Where feasible, the tagging information would be as inconspicuous as possible.

The tagging information may be in the form of a series of numbers, a bar code, or other identifying marks. All forms of rifle, pistol and shotgun ammunition are candidates for tagging with designating information by inscribing the information anywhere on the metallic casing, which is normally of brass material. The tagging would have no affect on the normal use of the ammunition or operation of a firearm in which the ammunition may be used.

Since ammunition having inscribed identifying indicia or tagging may be used in the commission of a crime and may be found at a crime scene, there exists an incentive by a purchaser and user of tagged ammunition to collect and properly recycle any empty cartridges or “spent brass” to avoid being involved in a criminal investigation. Shooting ranges, which may also sell ammunition, would have an incentive to collect any empty tagged cartridge casings in order to protect its customers from unnecessary legal entanglements. The present inventive concepts may be applied to use by civilian, police, government and military personnel. In an embodiment of the present invention, different designations may be used to distinguish between various user personnel.

An embodiment of the present invention is a method for identifying a purchaser of ammunition based on purchaser identifying indicia that comprises the steps of requesting a purchase of ammunition and providing identification and identifying indicia by an ammunition purchaser at a point-of-sale ammunition supplier location, verifying validity of the provided identification and identifying indicia by the point-of-sale ammunition supplier, refusing the ammunition purchase by the supplier if the provided identification and identifying indicia cannot be verified, inscribing the purchaser identifying indicia on the ammunition cartridge casing by the point-of-sale supplier if the provided identification and identifying indicia can be verified, selling the inscribed ammunition to the purchaser having verified identification and identifying indicia, and subsequently identifying the purchaser of the ammunition by the identifying indicia on the cartridge casing. The step of inscribing may further comprise inscribing a purchase date, a batch number, point-of-sale supplier identification and point-of-sale location on the ammunition cartridge casing. The step of verifying may be selected from the group consisting of comparing a photograph identification of the purchaser, comparing an online picture with the purchaser, comparing an online retinal scan with a purchaser retinal scan, and comparing an online fingerprint with a purchaser fingerprint. The step of inscribing the purchaser identifying indicia may be selected from the group consisting of inscribing the purchaser identifying indicia using a laser, and inscribing the purchaser identifying indicia using a scribing tool. The step of inscribing may be selected from the group consisting of inscribing the purchaser identifying indicia as an alphanumeric character sequence, and inscribing the purchaser identifying indicia as a bar code. The step of inscribing the purchaser identifying indicia may comprise inscribing the purchaser identifying indicia such that it cannot be seen by normal human observation. The step of inscribing the purchaser identifying indicia may comprise inscribing the purchaser identifying indicia such that it can be seen by normal human observation.

An alternative embodiment of the present invention is a system for identifying a purchaser of ammunition based on purchaser identifying indicia that comprises means for requesting a purchase of ammunition and providing identification and identifying indicia by an ammunition purchaser at a point-of-sale ammunition supplier location, means for verifying validity of the provided identification and identifying indicia by the point-of-sale ammunition supplier, means for refusing the ammunition purchase by the supplier if the provided identification and identifying indicia cannot be verified, means for inscribing the purchaser identifying indicia on the ammunition cartridge casing by the point-of-sale supplier if the provided identification and identifying indicia can be verified, means for selling the inscribed ammunition to the purchaser having verified identification and identifying indicia, and means for subsequently identifying the purchaser of the ammunition by the identifying indicia on the cartridge casing. The means for inscribing may be selected from the group consisting of a laser and a scribing tool. The means for inscribing may comprise a laser for inscribing a purchase date, a batch number, a point-of-sale supplier identification and a point-of-sale location on the ammunition cartridge casing. The means for verifying may be selected from the group consisting of a photograph identification for comparison with the purchaser, an online picture for comparison with the purchaser, an online retinal scan for comparison with a purchaser retinal scan, and an online fingerprint for comparison with a purchaser fingerprint. The means for inscribing may be selected from the group consisting of means for inscribing the purchaser identifying indicia as an alphanumeric character sequence, and means for inscribing the purchaser identifying indicia as a bar code. The identifying indicia may not visible by normal human observation. The identifying indicia may be visible by normal human observation.

### BRIEF DESCRIPTION OF DRAWINGS

These and other features, aspects and advantages of the present invention will become better understood with regard to the following description, appended claims, and accompanying drawings wherein:

FIG. 1 shows an embodiment of the present invention implemented at a point-of-sale location;

FIG. 2 shows an illustrative example of identifying markings on an ammunition cartridge casing; and

FIG. 3 shows a flow diagram of the method of the present invention.

### DETAILED DESCRIPTION

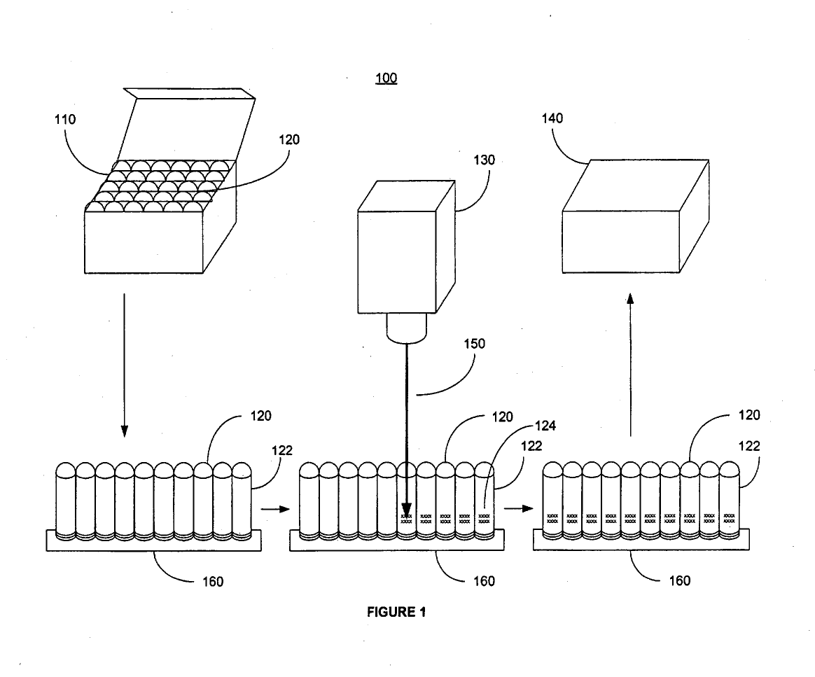

Turning now to FIG. 1, FIG. 1 shows an embodiment of the present invention implemented at a point-of-sale location 100 for marking ammunition cartridges 120 with identifying indicia 124 on the ammunition cartridge casing 122. The ammunition cartridges 120 are removed from a storage container 110 and positioned on a fixture 160 for holding and aligning the ammunition cartridges 120. The fixture 160 holding the ammunition cartridges 120 is passed beneath a laser beam 150 that inscribes identifying indicia 124 on each ammunition cartridge casing 122 as the ammunition cartridges 120 are moved passed a laser 130. When all the ammunition cartridge casings 120 positioned on a fixture 160 have been inscribed 124, they are replaced within another storage container 140 for selling to a customer.

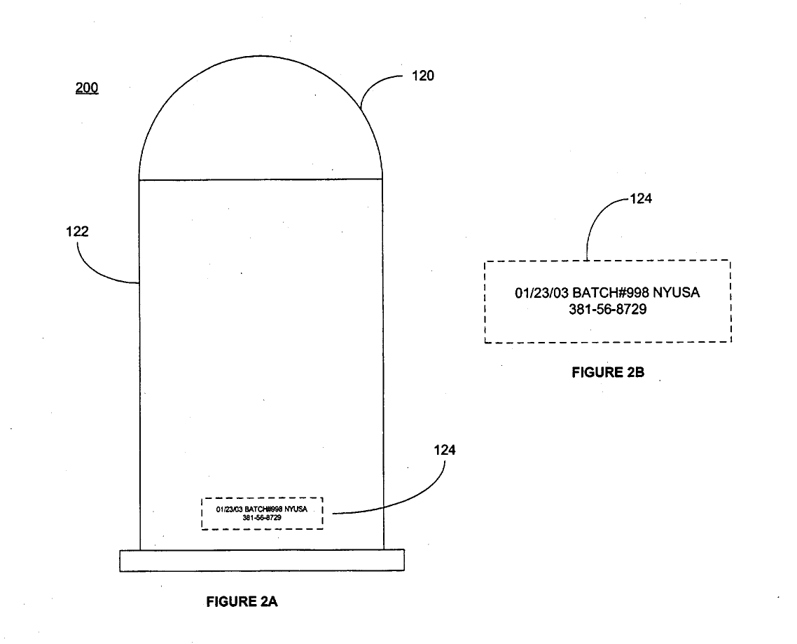

Turning to FIG. 2, FIG. 2 shows an illustrative example 200 of identifying indicia 124 on an ammunition cartridge casing 122. FIG. 2A shows an enlarged view of the ammunition cartridge 120 shown in FIG. 1. The identifying indicia 124 on the ammunition cartridge casing 122 is enlarged an illustrated in FIG. 2B. The identifying indicia 124 may be coded in many different ways, and the identifying indicia 124 shown in FIG. 2B is an illustrative example of one embodiment of identifying indicia. The identifying indicia 124 shown in FIG. 2B includes a date of sale, a batch number, which may identify a point-of-sale supplier, a location code, and a purchaser's identifying indicia, such as a social security number. The purchaser's identifying indicia may be coded as other designations, such as a driver's license, or a federal identification number.

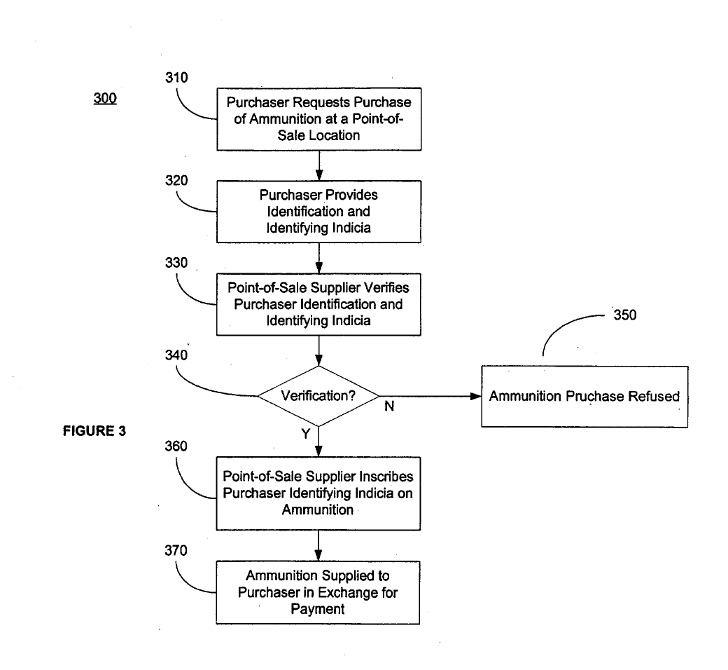

Turning now to FIG. 3, FIG. 3 shows a flow diagram 300 of the method of the present invention. When a purchaser requests to purchase ammunition at a point-of-sale location 310, the purchaser is requested to provide identification and identifying indicia 320. The point-of-sale supplier verifies that the purchaser identification and identifying indicia is correct and valid 330. There are various means for determining correctness and validity, such as an online database containing pictures of people with identifying indicia. Retinal scans and fingerprints, coupled with an inline database may also provide a means for verifying correctness and validity. A picture form of identification, such as a driver's license may also verification. If the purchaser identification and identifying indicia cannot be verified 340, the request to purchase ammunition is refused 350. If the purchaser identification and identifying indicia can and is verified 340, the point-of-sale supplier inscribes the purchaser identifying indicia and other information, as described in reference to FIG. 2B, on the ammunition cartridge cases 360, and sells the marked ammunition to the purchaser 370.

Although the present invention has been described in detail with reference to certain preferred embodiments, it should be apparent that modifications and adaptations to those embodiments might occur to persons skilled in the art without departing from the spirit and scope of the present invention.

1. A method for identifying a purchaser of ammunition based on purchaser identifying indicia, comprising the steps of:
requesting a purchase of ammunition and providing identification and identifying indicia by an ammunition purchaser at a point-of-sale ammunition supplier location;
verifying validity of the provided identification and identifying indicia by the point-of-sale ammunition supplier;
refusing the ammunition purchase by the supplier if the provided identification and identifying indicia cannot be verified;
inscribing the purchaser identifying indicia on the ammunition cartridge casing by the point-of-sale supplier if the provided identification and identifying indicia can be verified;
selling the inscribed ammunition to the purchaser having verified identification and identifying indicia; and
subsequently identifying the purchaser of the ammunition by the identifying indicia on the cartridge casing.

2. The method of claim 1, wherein the step of inscribing further comprises inscribing a purchase date, a batch number, point-of-sale supplier identification and point-of-sale location on the ammunition cartridge casing.

3. The method of claim 1, wherein the step of verifying is selected from the group consisting of comparing a photograph identification of the purchaser, comparing an online picture with the purchaser, comparing an online retinal scan with a purchaser retinal scan, and comparing an online fingerprint with a purchaser fingerprint.

4. The method of claim 1, wherein the step of inscribing the purchaser identifying indicia is selected from the group consisting of inscribing the purchaser identifying indicia using a laser, and inscribing the purchaser identifying indicia using a scribing tool.

5. The method of claim 1, wherein the step of inscribing is selected from the group consisting of inscribing the purchaser identifying indicia as an alphanumeric character sequence, and inscribing the purchaser identifying indicia as a bar code.

6. The method of claim 1, wherein the step of inscribing the purchaser identifying indicia comprises inscribing the purchaser identifying indicia such that it cannot be seen by normal human observation.

7. The method of claim 1, wherein the step of inscribing the purchaser identifying indicia comprises inscribing the purchaser identifying indicia such that it can be seen by normal human observation.

8. A system for identifying a purchaser of ammunition based on purchaser identifying indicia,.comprising:
means for requesting a purchase of ammunition and providing identification and identifying indicia by an ammunition purchaser at a point-of-sale ammunition supplier location;
means for verifying validity of the provided identification and identifying indicia by the point-of-sale ammunition supplier;
means for refusing the ammunition purchase by the supplier if the provided identification and identifying indicia cannot be verified;
means for inscribing the purchaser identifying indicia on the ammunition cartridge casing by the point-of-sale supplier if the provided identification and identifying indicia can be verified;
means for selling the inscribed ammunition to the purchaser having verified identification and identifying indicia; and
means for subsequently identifying the purchaser of the ammunition by the identifying indicia on the cartridge casing.

9. The system of claim 8, wherein the means for inscribing is selected from the group consisting of a laser and a scribing tool.

10. The system of claim 8, wherein the means for inscribing comprises a laser for inscribing a purchase date, a batch number, point-of-sale supplier identification and point-of-sale location on the ammunition cartridge casing.

11. The system of claim 8, wherein the means for verifying is selected from the group consisting of a photograph identification for comparison with the purchaser, an online picture for comparison with the purchaser, an online retinal scan for comparison with a purchaser retinal scan, and an online fingerprint for comparison with a purchaser fingerprint.

12. The system of claim 8, wherein the means for inscribing is selected from the group consisting of means for inscribing the purchaser identifying indicia as an alphanumeric character sequence, and means for inscribing the purchaser identifying indicia as a bar code.

13. The system of claim 8, wherein the identifying indicia is not visible by normal human observation.

14. The system of claim 8, wherein the identifying indicia is visible by normal human observation.
